(19) United States
(12) Patent Application Publication
(10) Pub. No.: US 2004/0037426 A1
(43) Pub. Date: Feb. 26, 2004

(54) Apparatus for converting to six-channel outputs from two-channel

(75) Inventors: Ching-Jung Chu, Taipei (TW); Ta-Jung Yeh, Taipei (TW); Feng-Sheng Chang, Taipei (TW); I-Cheng Tsou, Taipei (TW); Chi-Yi Lee, Taipei (TW); Weishang Chu, Taipei (TW)

Correspondence Address: BACON & THOMAS, PLLC, 625 SLATERS LANE, FOURTH FLOOR, ALEXANDRIA, VA, 22314

(73) Assignee: VIA Technologies, Inc., Taipei (TW)

(21) Appl. No.: 10/638,422

(22) Filed: Aug. 12, 2003

(30) Foreign Application Priority Data
Aug. 21, 2002 (TW) 91118938

(51) Int. Cl. H04R 5/00

(52) U.S. Cl. 381/22; 381/23

(57) ABSTRACT

A apparatus formed on a motherboard of computer complied with PC99 standard for converting to six-channel output from two-channel is disclosed. The apparatus comprises a CODEC, a MIC_IN connector switch, first, second, and third filters, and a resistor circuit. In a six-channel output mode, the rear left and rear right surround signals and LINE_IN_L and LINE_IN_R signals are fed into the third filter.

### BACKGROUND OF THE INVENTION

1. Field of the Invention

The present invention relates to an audio apparatus and, more particularly, to an apparatus formed on a motherboard of computer for converting to six-channel outputs to two-channel.

2. Description of Related Art

On a conventional all-in-one motherboard, there are provided three audio connectors, i.e., LINE_OUT, LINE_IN and MIC_IN connectors, based on PC99 standard. The LINE_OUT connector is able to provided a two-channel output. The LINE_IN connector is coupled to an external microphone so that a user can input his/her voice therein. The MIC_IN connector is coupled to a LINE_OUT connector of a stereo via a cable so as to input sounds into the stereo. A six-channel stereo is comprised of a left speaker, a right speaker, a central speaker, a low-frequency-effect speaker, a surround left speaker, and a surround right speaker. However, only the LINE_OUT connector on the motherboard is able to provide left channel and right channel outputs based on PC99 standard. Hence, there is still a limitation in outputting a six-channel effect on a motherboard complied with PC99 standard.

Therefore, it is desirable to provide a novel apparatus formed on a motherboard of computer for converting to six-channel outputs from two-channel in order to mitigate and/or obviate the aforementioned problems.

### SUMMARY OF THE INVENTION

An object of the present invention is to provide an apparatus formed on a motherboard of computer complied with PC99 standard for converting to six-channel outputs from two-channel.

To achieve the object, there is provided an apparatus for converting to six-channel outputs from two-channel and using a MIC_IN connector, a LINE_IN connector, and a LINE_OUT connector for outputting six-channel sound effect. The apparatus comprises: a coder/decoder (CODEC) for coding or decoding sound signals so as to output central channel signal, low-frequency-effect signal, surround left signal, surround right signal, left channel signal, and right channel signal, input microphone signal, LINE_IN_L and LINE_IN_R signals, and generate control signal; a MIC_IN connector switch for switching the MIC_IN connector as an input means or an output means based on the control signal; a first filter for coupling the central signal and the low-frequency-effect signal to the MIC_IN connector; a second filter for coupling the microphone signal inputted by the MIC_IN connector to the CODEC; a third filter for coupling LINE_IN_L and LINE_IN_R signals inputted by the LINE_IN connector to the CODEC; and a resistor circuit for coupling the surround left signal and the surround right signal to the LINE_IN connector for output via the third filter.

Other objects, advantages, and novel features of the invention will become more apparent from the detailed description when taken in conjunction with the accompanying drawings.

### BRIEF DESCRIPTION OF THE DRAWINGS

FIG. 1 is a block diagram of the apparatus for converting to six-channel outputs from two-channel according to the invention;

FIG. 2 is a circuit diagram of the apparatus for converting to six-channel outputs from two-channel according to the invention;

FIG. 3 is an equivalent circuit diagram of the present apparatus in normal operation; and

FIG. 4 is an equivalent circuit diagram of the present apparatus performing a six-channel output operation.

### DETAILED DESCRIPTION OF THE PREFERRED EMBODIMENT

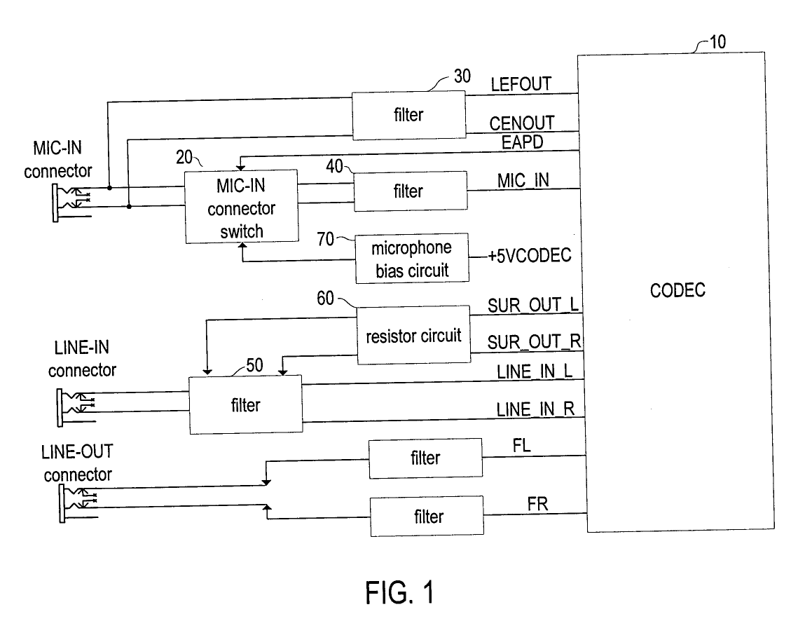

With reference to FIG. 1, there is shown an apparatus for converting to six-channel output from two-channel in accordance with the invention. The apparatus comprises a coder/decoder (CODEC) 10, a MIC_IN connector switch 20, a first filter 30, a second filter 40, a third filter 50, a resistor circuit 60, and a microphone bias circuit 70. The CODEC 10 is able to code or decode sound signals for output, and generate a control signal EAPD. The MIC_IN connector switch 20 acts to convert signals sent from a MIC_IN connector coupled to an external microphone into a central signal (CENOUT) and a low-frequency-effect signal (LFEOUT), respectively. LINE_IN_L and LINE_IN_R signals inputted from a LINE_IN connector are converted into surround left signal (SUR_OUT_L) and surround right signal (SUR_OUT_R), respectively. Finally, left and front right signals are outputted from a LINE_OUT connector.

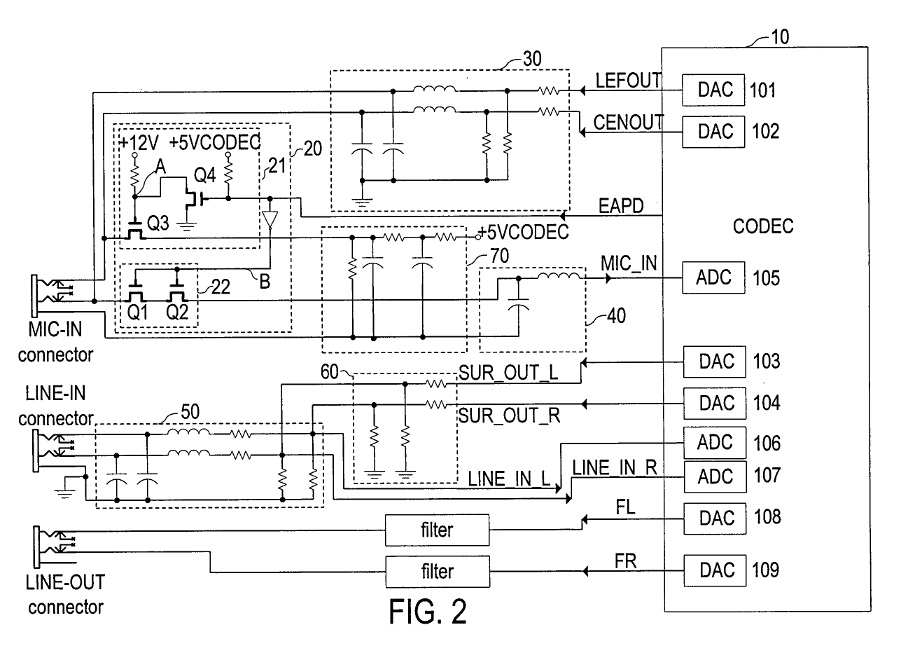

With reference to FIG. 2, a circuit diagram of FIG. 1 is illustrated. As shown, the central signal CENOUT and the low-frequency-effect signal LFEOUT are outputted from digital-to-analog converters (DACs) 101 and 102 in the CODEC 10. Next, the central signal CENOUT and the low-frequency-effect signal LFEOUT are sent to the MIC_IN connector for output via the first filter 30.

The CODEC 10 issues the control signal EAPD to control the MIC_IN connector switch 20. The MIC_IN connector switch 20 has a first switch 21 and a second switch 22. A microphone bias voltage (+5VCODEC) is applied to the first switch 21 via the microphone bias circuit 70, and is further applied to the MIC_IN connector. Thus, a microphone can be suitably biased once coupled to the MIC_IN connector. A microphone signal is sent to a second filter 40 via the second switch 22. A MIC_IN output signal from the second filter 40 is sent to an analog-to-digital converter (ADC) 105 of the CODEC 10.

The surround left signal SUR_OUT_L and the surround right signal SUR_OUT_R are outputted from DACs 103 and 104 in the CODEC 10. Next, the surround left signal SUR_OUT_L and the surround right signal SUR_OUT_R are sent to a third filter 50 via the resistor circuit 60. Finally, the surround left signal SUR_OUT_L and the surround right signal SUR_OUT_R are sent to and then outputted from the LINE_IN connector.

An external sound source is fed into the device via the LINE_IN connector. In detail, sound signal is sent to a third filter 50 from the LINE_IN connector. The output terminals LINE_IN_L and LINE_IN_R are coupled to ADCs 106 and 107 of the CODEC 10, respectively.

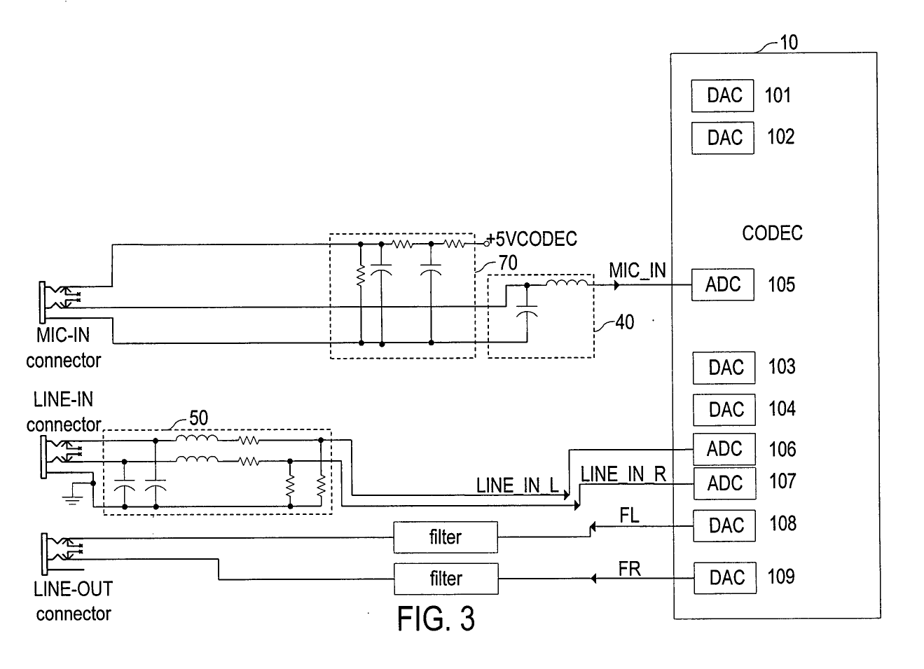

With reference to FIG. 3 in conjunction with FIG. 2, a two-channel output of the device is illustrated. First, the CODEC 10 outputs a low control signal EAPD. Thus, the transistor Q4 of the first switch 21 is off. Voltage at a node A is high, thus turning on a transistor Q3 of the first switch 21. The microphone bias voltage +5VCODEC is applied to the MIC_IN connector via the microphone bias circuit 70. Hence, an appropriate voltage may be applied to a microphone signal when the microphone is coupled to the MIC_IN connector. Transistors Q1 and Q2 of the second switch 22 are both on since the control signal EAPD is low and a voltage at a node B is high. Next, the microphone signal is sent to the CODEC 10 via the second filter 40.

At this time, the ADCs 105, 106 and 107 are enabled by the CODEC 10. Once enabled, the ADCs 105, 106, and 107 are able to receive input signals. Also, the DACs 101, 102, 103, and 104 are off, i.e., outputs thereofare in a high impedance state. Further, the DACs 108 and 109 are enabled to output sound signals from the LINE_OUT connector via filters. The equivalent circuit is shown in FIG. 3. As shown, the MIC_IN, the LINE_IN, and the LINE_OUT connectors are complied with PC99 standard.

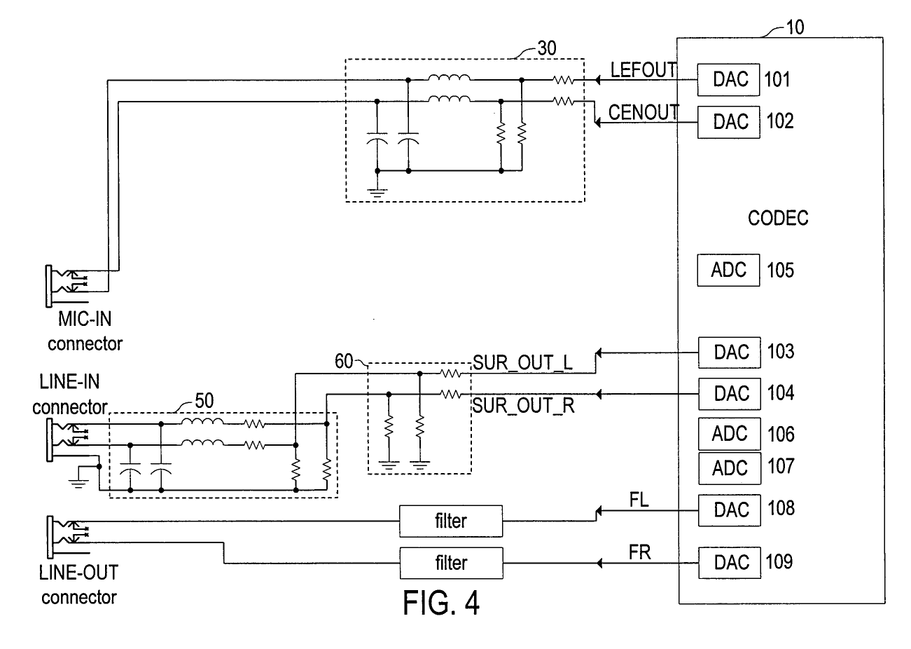

With reference to FIG. 4 in conjunction with FIG. 2, a six-channel output of the device is illustrated. First, the CODEC 10 outputs a high control signal EAPD. Thus, the transistor Q4 is turned on. Voltage at the node A is low, thus turning off the transistor Q3. The microphone bias voltage +5VCODEC is prohibited from applying to the MIC_IN connector via the microphone bias circuit 70 due to the transistor Q3 being off. Hence, it is possible of avoiding the interference from occurring on the central signal CENOUT. The transistors Q1 and Q2 are turned off since the control signal EAPD is high and voltage at the node B is low. Hence, the low-frequency-effect signal LFEOUT will not be fed into the CODEC 10 via the second filter 40.

At this time, the DACs 101, 102, 103, 104, 108, and 109 are enabled by the CODEC 10. Once enabled, the DACs 101, 102, 103, 104, 108, and 109 are able to output sound signals. Also, the ADCs 105, 106, and 107 are off; i.e., outputs thereof are in a high impedance state. The equivalent circuit is shown in FIG. 4. As shown, the apparatus provides a six-channel output.

In view of the foregoing, it is known that, with the present apparatus, a user can listen to a six-channel output from a motherboard complied with PC99 standard. Also, in the six-channel output mode, the surround left and right signals share the third filter with the LINE_IN_L and LINE_IN_R signals, so as to save the cost.

Although the present invention has been explained in relation to its preferred embodiment, it is to be understood that many other possible modifications and variations can be made without departing from the spirit and scope of the invention as hereinafter claimed.

What is claimed is:

1. A apparatus for converting to six-channel output from two-channel and using a MIC_IN connector, a LINE_IN connector, and a LINE_OUT connector for outputting six-channel sound effect, comprising:
a coder/decoder (CODEC) for coding or decoding sound signals so as to output central channel signal, low-frequency-effect signal, surround left signal, surround right signal, left channel signal, and right channel signal, input microphone signal, LINE_IN_L and LINE_IN_R signals, and generate control signal;
a MIC_IN connector switch for switching the MIC_IN connector as an input means or an output means based on the control signal;
a first filter for coupling the central signal and the low-frequency-effect signal to the MIC_IN connector;
a second filter for coupling the microphone signal inputted by the MIC_IN connector to the CODEC;
a third filter for sending LINE_IN_L and LINE_IN_R signals inputted by the LINE_IN connector to the CODEC; and
a resistor circuit for coupling the surround left signal and the surround right signal to the LINE_IN connector for output via the third filter.

2. The apparatus as claimed in claim 1, further comprising a microphone bias circuit for biasing the microphone signal inputted by the MIC_IN connector with a microphone bias signal.

3. The apparatus as claimed in claim 2, wherein the MIC_IN connector switch comprises a first switch and a second switch, so that, in response to the control signal in a low state, the first switch is operative to send the biased microphone signal to the MIC_IN connector and the second switch is operative to send the microphone signal fed from the MIC_IN connector to the CODEC via the second filter.

4. The apparatus as claimed in claim 3, wherein the first switch is comprised of a third N channel metal oxide semiconductor (NMOS) transistor and a fourth NMOS transistor so that the third NMOS transistor is turned on and the fourth NMOS transistor is turned off for biasing the inputted microphone signal in response to the low control signal.

5. The apparatus as claimed in claim 3, wherein the second switch is comprised of a first NMOS transistor and a second NMOS transistor so that both the first and the second NMOS transistors are turned on for sending the inputted microphone signal to the second filter in response to the low control signal.

6. The apparatus as claimed in claim 1, wherein the CODEC further comprises a plurality of digital-to-analog converters (DACs) corresponding to the central channel signal, the low-frequency-effect signal, the surround left signal, the surround right signal, the left channel signal, and the right channel signal, respectively, and a plurality of analog-to-digital converters (ADCs) corresponding to the microphone signal, the LINE_IN_L signal, and the LINE_IN_R signal, respectively.

7. The apparatus as claimed in claim 6, wherein, in a six-channel output mode, the CODEC enables the DACs corresponding to the central channel signal, the low-frequency-effect signal, the surround left signal, the surround right signal, the left channel signal, and the right channel signal, respectively.

8. The apparatus as claimed in claim 7, wherein, in a six-channel output mode, the CODEC disables the ADCs corresponding to the microphone signal, the LINE_IN_L signal, and the LINE_IN_R signal, respectively.

9. The apparatus as claimed in claim 5, wherein, in a non-six-channel output mode, the CODEC disables the DACs corresponding to the central channel signal, the low-frequency-effect signal, the surround left signal, the surround right signal, the left channel signal, and the right channel signal, respectively.

10. The apparatus as claimed in claim 9, wherein, in a non-six-channel output mode, the CODEC enables the ADCs corresponding to the microphone signal, the LINE_IN_L signal, and the LINE_IN_R signal, respectively.
